(19) United States
(12) Patent Application Publication
(10) Pub. No.: US 2019/0382284 A1
(43) Pub. Date: Dec. 19, 2019

(54) WATER TREATMENT DEVICE

(71) Applicant: KLEAN ENERGY CORPORATION LIMITED, Taichung (TW)

(72) Inventors: LI-TU WANG, Taichung (TW); YU-TANG SHU, Taipei (TW)

(21) Appl. No.: 16/009,655

(22) Filed: Jun. 15, 2018

(51) Int. Cl. C02F 1/00; C02F 9/00; B65D 43/02; B65D 25/00; B65D 25/28

(52) U.S. Cl. CPC C02F 1/005; C02F 9/00; B65D 43/0202; C02F 1/38; B65D 25/2858; C02F 1/001; B65D 25/005

(57) ABSTRACT

A water treatment device for placing into a water storage container, which comprises a casing and physical multi-impact liquid-state energy water. The casing includes an accommodating space, and the physical multi-impact liquid-state energy water is composed of micronized water molecules with the liquid-state energy of micro-vibration elements in order to meet the requirement of the nuclear magnetic resonance (NMR) half-width high frequency value below 90 Hz. And the physical multi-impact liquid-state energy water is accommodated in the accommodating space. Accordingly, after the casing is placed in the water storage container, the water in the water storage container can be activated by the physical multi-impact liquid-state energy water in a physical resonant manner, so that the water with originally larger water molecular groups in the water storage container may be refined into water with smaller water molecular groups.

### FIELD OF THE INVENTION

The present invention relates to a water storage container article and more particularly to a water treatment device placing into the water storage container.

### BACKGROUND OF THE INVENTION

Water is an essential part of human life, and good water is an important factor in maintaining good health. With the excessive development of the chemical industry, human life is full of various chemical products. Long-term drinking and eating of beverages and foods made by chemical methods has a great influence on the health of body. It is a common knowledge that drinking plenty of water is good for health, but water produced by chemical manufacturing processes is not natural. Drinking more is not necessarily good for your health.

Generally, sources that can be used for drinking water include tap water, well water, river water, etc., which are formed by a plurality of water molecules combined by hydrogen bond to form water molecular groups. Different water sources have different water molecular groups. Studies have pointed out that drinking water with small molecular groups contributes to the health of body because of the strong dispersity of water with small molecular groups, which can promote the dispersion of red blood cells after drinking Water with small molecular groups has strong osmotic power, can easily penetrate the cell wall to nourish the cells, thereby reducing the blood viscosity of human. And because it can promote biochemical effect inside the human body, enhance the activity of various enzymes, and can also decompose blood lipid and lower the blood lipid index, thus can promote health.

Nowadays, nuclear magnetic resonance (NMR) half-width high-frequency detection method is commonly used internationally to detect the size of water molecular group. In general, the smaller the NMR half-width high frequency value, the smaller the water molecular group, and contrarily, the larger value, the larger the water molecular group. The NMR half-width high-frequency value of general tap water, well water, river water, and rain water are all above 100 Hz (hertz), and can even be as high as 157 Hz. Generally, the higher the value of the NMR half-width high frequency, it represents that the water contains more contaminants or undesirable ions such as sodium, which is classified as poor quality drinking water.

In nature, the NMR half-width high frequency value of preferred natural water with small molecular groups, such as glacial spring water, is generally about 63 Hz, while the NMR half-width high frequency value of deep ocean water below 300 meters is about 53.2 Hz, which are preferred drinking water.

In areas with insufficient water resources, water storage container is an equipment that must be set up for every household that can be used for storing water, and can solve the problems of low water pressure and occasional suspension of water supply. In order to ensure the hygiene and safety of household water, some people will install a water purification device in the water storage container. The traditional water purification device is a simple filtration device that allows water to pass through a porous material to adsorb impurities, and an activated carbon material can also be installed to absorb odor.

However, the above-mentioned conventional filter devices can only remove impurities and odors, and cannot fundamentally change the size of the water molecular groups, in other words, cannot effectively improve the water quality.

### SUMMARY OF THE INVENTION

Therefore, a main object of the present invention is to provide a water treatment device including physical multi-impact liquid-state energy water, which is able to activate the water in the water storage container in a physical resonant manner so that the water is refined to fundamentally change the water quality and thus promote health.

Based on the above object, the present invention provides a water treatment device placed into a water storage container. The water treatment device comprises a casing and physical multi-impact liquid-state energy water. The casing includes an accommodating space, and the physical multi-impact liquid-state energy water is composed of micronized water molecules with the liquid-state energy of micro-vibration elements in order to meet the requirement of nuclear magnetic resonance (NMR) half-width high frequency value below 90 Hz. And the physical multi-impact liquid-state energy water is accommodated in the accommodating space.

Wherein, the physical multi-impact liquid-state energy water is manufactured by passing water through a coarse filtration process, a first standstill process, a fine filtration process, a second standstill process, a centrifugal process, a third standstill process and at least one spiral pressurization process to produce the physical multi-impact liquid-state energy water.

The physical multi-impact liquid-state energy water is able to activate the water molecular groups in an adjacent area through physical resonance, allows the water molecular groups in the adjacent area to be refined, and fundamentally changes the size of the water molecular groups.

Wherein, the water may be selected from tap water, well water, river water, and the like. The coarse filtration process allows the water to pass through a fiber filter cartridge, and an optimal fiber filter cartridge is one with an aperture of 5 micrometers; the first standstill process allows the water to stand for at least 6 hours; the fine filtration process allows the water to further pass through an activated carbon filter cartridge and a KDF filter cartridge; the second standstill process allows the water to stand for at least 6 hours; the centrifugal process allows the water to be placed into a rotating barrel that runs at 1800-6000 revolutions per minute (RPM) to rotate the water to display a vortical distribution, and the water is drawn above the vortical distribution of the water to complete the centrifugal process; the third standstill process allows the water to stand for at least 6 hours; and the spiral pressurization process allows the water to enter into a spiral pressurized barrel at a flow rate of 3.2-5.2 meters/second (m/S). The spiral pressurized barrel includes a tube body, and an inlet and an outlet respectively disposed at two ends of the tube body. A cylindrical body is disposed at a center of the tube body, and a spiral guide plate is circumferentially disposed on the cylindrical body. The water enters the tube body through the inlet to impact the spiral guide plate. The water will impact repeatedly in a gap between the spiral guide plate and the tube body, and the water is flowed out of the outlet through the guiding of the spiral guide plate. Thereby, the physical multi-impact liquid-state energy water is produced.

Accordingly, the present invention does not require electric power and has no chemical additives, and includes features and functions such as energy conservation, emission reduction, environmental protection and safety. After the casing is placed in the water storage container, the water in the water storage container may be activated by the physical multi-impact liquid-state energy water in a physical resonant manner, so that the water with originally larger water molecular groups in the water storage container may be refined into the water with smaller water molecular groups. The water quality of the water storage container may be improved for people's use and may help maintain people's health.

### BRIEF DESCRIPTION OF THE DRAWINGS

FIG. 1 is a structural sectional view of a water treatment device according to the present invention;

FIG. 2 is a perspective view of the water treatment device according to a first embodiment of the present invention;

FIG. 3 is a structural exploded view of the water treatment device according to a first embodiment of the present invention;

FIG. 4 is a structural bottom view of the water treatment device according to a first embodiment of the present invention;

FIG. 5 is a perspective view of the water treatment device according to a second embodiment of the present invention; and

FIG. 6 is a structural exploded view of the water treatment device according to a second embodiment of the present invention.

### DETAILED DESCRIPTION OF THE PREFERRED EMBODIMENTS

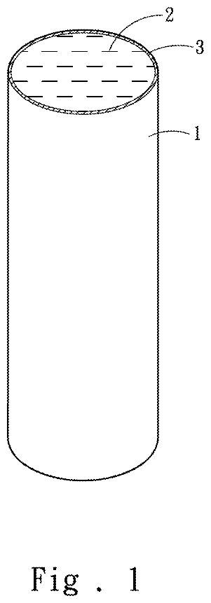

Referring to FIG. 1, the present invention is a water treatment device for placing into a water storage container (not shown in the FIG.). The water storage container can be a water tower, a water bucket, a kettle, a water dispenser, and the like. The water treatment device comprises a casing 1 and a physical multi-impact liquid-state energy water 2. The casing 1 includes an accommodating space 3, and the physical multi-impact liquid-state energy water 2 is composed of micronized water molecules with the liquid-state energy of micro-vibration elements in order to meet the requirement of the nuclear magnetic resonance (NMR) half-width high frequency value below 90 Hz. And the physical multi-impact liquid-state energy water 2 is accommodated in the accommodating space 3. The structure of the casing 1 is not limited to cylindrical, long columnar, triangular columnar, spherical, egg shaped and elliptic spherical, and the like.

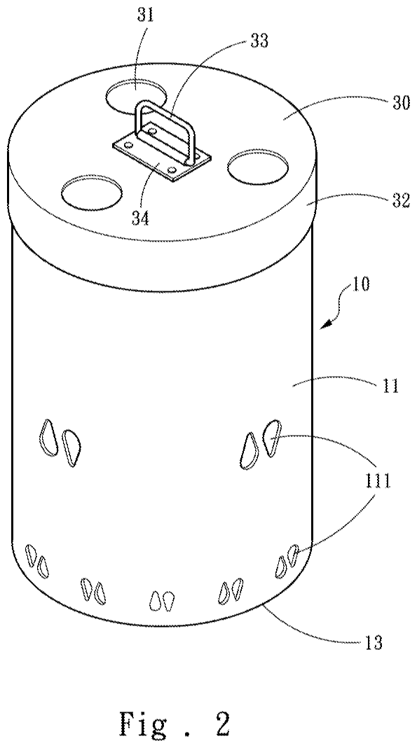

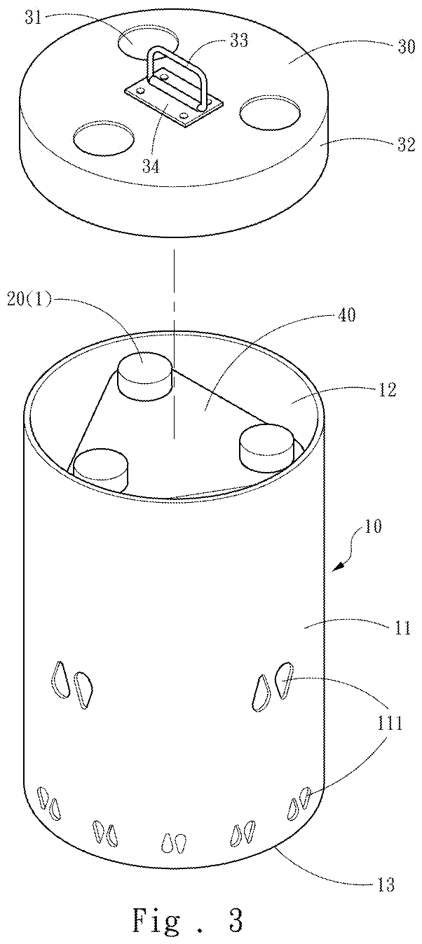

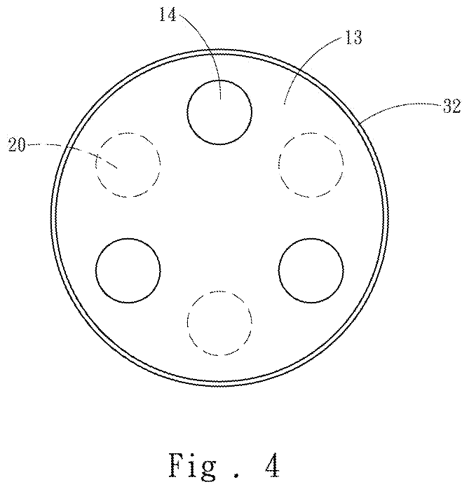

Referring to FIG. 2, FIG. 3 and FIG. 4 for a first embodiment of the present invention, the water treatment device may further include a bucket body 10, a plurality of water storage tanks 20, and a bucket lid 30. The bucket body 10 includes a barrel 11, an upper opening 12 disposed at an upper side of the barrel 11 and a bottom plate 13 disposed at a lower side of the barrel 11. The barrel 11 is disposed with a plurality of openings 111, and the bottom plate 13 is disposed with a plurality of lower round holes 14. The plurality of water storage tanks 20 are composed of the casings 1 filled with the physical multi-impact liquid-state energy water 2, and are disposed on the bottom plate 13. As shown in FIG. 1, each of the plurality of water storage tanks 20 is composed of one casing 1 and filled with the physical multi-impact liquid-state energy water 2 inside. The plurality of water storage tanks 20 and the plurality of lower round holes 14 are alternately disposed. The bucket lid 30 covers the upper opening 12 and has a plurality of upper circular holes 31 corresponding to the plurality of water storage tanks 20, and the bucket lid 30 can have a skirt 32 covering the upper opening 12 to prevent the bucket lid 30 from falling off.

In order to facilitate the opening of the bucket lid 30, the bucket lid 30 may include a lifting lug 33. Besides, in order to prevent the lifting lug 33 from falling off, the lifting lug 33 may be fixed to the bucket lid 30 through a reinforcing plate 34. The present invention may further comprise a fixing plate 40. The fixing plate 40 loops and fixes the plurality of water storage tanks 20 in order to prevent the plurality of water storage tanks 20 from falling off.

In order to increase the amount of water of the water storage container flowing into the water treatment device, the plurality of openings 111 may be arranged in two rows and disposed around the barrel 11. Further, the size of the plurality of openings 111 at an upper position may be larger than the size of the plurality of openings 111 at a lower position.

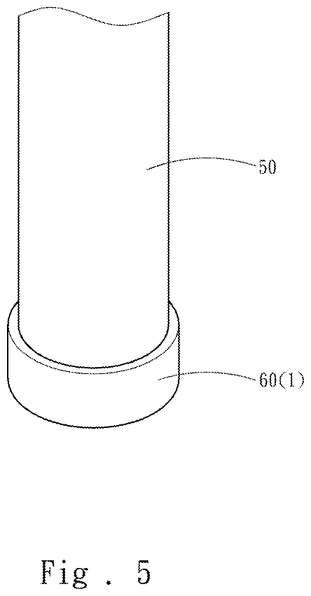

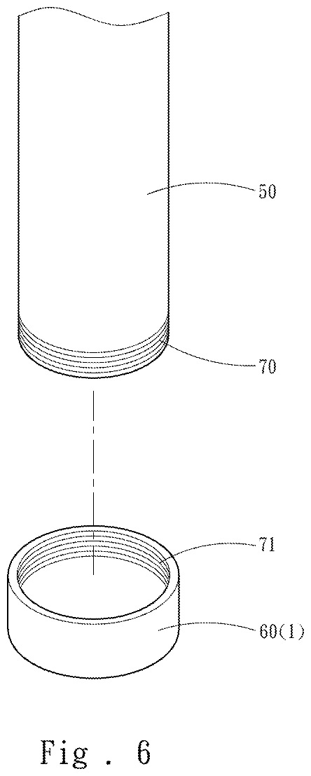

Referring to FIG. 1, FIG. 5 and FIG. 6 for a second embodiment of the present invention, the water treatment device may comprise a bottle 50 and a fixing base 60. The fixing base 60 is composed of the casing 1 filled with the physical multi-impact liquid-state energy water 2. That is to say, the fixing base 60 is composed of the casing 1 shown in FIG. 1 and filled with the physical multi-impact liquid-state energy water 2 inside. The fixing base 60 is coupled and fixed on the bottle 50. In a preferred embodied manner, the bottle 50 and the fixing base 60 are provided with engaging structures 70 and 71, such as threads and engaging grooves. Through the engaging between the two engaging structures 70 and 71, the fixing base 60 is fixedly coupled to a bottom of the bottle 50. The bottle 50 may be a kettle, hot and cold water bottles, etc., and the fixing base 60 may be a cylinder or disk corresponding to the bottle 50.

In summary, the present invention allows the casing (the water storage tank) to be filled with the physical multi-impact liquid-state energy water and placed into the water storage container. Thereby, because the physical multi-impact liquid-state energy water is composed of micronized water molecules with the liquid-state energy of micro-vibration elements, when the water of the water storage container contacts with the casing (the water storage tank), the physical multi-impact liquid-state energy water may activate the water of the water storage container through physical resonance. The water in the water storage container will be refined after being activated, and after the water used by people it may help maintain people's health and meet the needs and requirements of use.

According to the results of water quality sample inspection report No. B1050985-1 (Assignment No. YZ1051B0985) of the Environmental Technology Research Center of Yuan Ze University, it may be known that the hydrogen ion concentration index (pH value) of the water treated with the present invention may reach pH 7.7, and the dissolved oxygen can reach 7.5 mg/L. While the quality of general tap water, its hydrogen ion concentration index is about pH 6.5-7, and the dissolved oxygen is about 4-5 mg/L. Obviously, the present invention can assuredly increase the pH value and dissolved oxygen.

According to the calculation based on the research of Hungkuang University, the sample water treated by the present invention is detected by nuclear magnetic resonance spectrometer, its NMR half-width high frequency value is 72.3±5 Hz, which is obviously lower than that of general tap water, well water, river water and rain water. It may increase the water quality to meet the needs and requirements of use.

As described above, the advantages of the water treatment device of the present invention in comparing with conventional ones at least include:

1. The present invention does not require electric power and has no chemical additives, and has features and functions such as energy conservation, emission reduction, environmental protection and safety.

2. The present invention has the function of increasing dissolved oxygen in water.

3. The water treated by the present invention can preserve the freshness of vegetables and fruits (prolongs the preservation time by more than 20%).

4. The water treated by the present invention can inhibit all anaerobic bacteria.

5. The present invention is able to raise the pH value to pH 7-8.5 to change the water from weak acid to weak alkaline.

6. The present invention includes the function of converting large water molecular groups into small water molecular groups.

7. The water treated by the present invention includes the functions of promoting blood circulation of human body and increasing blood flow by more than 20%.

What is claimed is:

1. A water treatment device for placing into a water storage container, comprising:
a casing including an accommodating space; and
physical multi-impact liquid-state energy water composed of micronized water molecules with the liquid-state energy of micro-vibration elements in order to meet the requirement of nuclear magnetic resonance (NMR) half-width high frequency value below 90 Hz, and the physical multi-impact liquid-state energy water being accommodated in the accommodating space.

2. The water treatment device according to claim 1, wherein the casing is selected from any one of cylindrical, long columnar, triangular columnar, spherical, egg shaped and elliptic spherical.

3. The water treatment device according to claim 1, wherein the water treatment device comprises a bucket body, a plurality of water storage tanks and a bucket lid, the bucket body includes a barrel and an upper opening and a bottom plate respectively disposed at an upper side and a lower side of the barrel, the barrel is disposed with a plurality of openings, and the bottom plate is disposed with a plurality of lower round holes; the plurality of water storage tanks are composed of the casings filled with the physical multi-impact liquid-state energy water, and the plurality of water storage tanks are disposed on the bottom plate, and the plurality of water storage tanks and the plurality of lower round holes are alternately disposed; the bucket lid covers the upper opening and includes a plurality of upper circular holes corresponding to the plurality of water storage tanks.

4. The water treatment device according to claim 3, wherein the bucket lid includes a lifting lug.

5. The water treatment device according to claim 4, wherein the lifting lug is fixed to the bucket lid through a reinforcing plate.

6. The water treatment device according to claim 3, wherein the water treatment device comprises a fixing plate looping and fixing the plurality of water storage tanks.

7. The water treatment device according to claim 3, wherein the plurality of openings are arranged in two rows and disposed around the barrel.

8. The water treatment device according to claim 7, wherein the size of the plurality of openings at an upper position is larger than the size of the plurality of openings at a lower position.

9. The water treatment device according to claim 3, wherein the bucket lid includes a skirt covering the upper opening.

10. The water treatment device according to claim 1, wherein the water treatment device further comprises a bottle and a fixing base, the fixing base is composed of the casing filled with the physical multi-impact liquid-state energy water, the fixing base is fixedly coupled to a bottom of the bottle through two engaging structures which respectively provided on the bottle and the fixing base.
